(19) United States
(12) Patent Application Publication
(10) Pub. No.: US 2017/0120898 A1
(43) Pub. Date: May 4, 2017

(54) APPARATUS AND METHOD FOR SHIFT CONTROL OF HYBRID VEHICLE

(71) Applicant: HYUNDAI MOTOR COMPANY, Seoul (KR)

(72) Inventor: Sang Joon KIM, Seoul (KR)

(21) Appl. No.: 15/228,507

(22) Filed: Aug. 4, 2016

(30) Foreign Application Priority Data
Oct. 28, 2015 (KR) 10-2015-0150347

(51) Int. Cl. B60W 20/40; B60W 10/08; B60K 6/22; B60W 10/06

(52) U.S. Cl. CPC B60W 20/40; B60W 10/06; B60W 10/08; B60K 6/22; B60W 2510/0638; B60L 2210/10; B60W 2510/081; B60W 2510/244; B60W 2710/0666; B60W 2710/083; B60Y 2300/182; Y10S 903/915

(57) ABSTRACT

A method for shift control of a hybrid vehicle includes determining a target speed of a transmission resulting from a shifting operation, and performing torque intervention control that controls a motor torque in a state where an engine torque is maintained as a current torque until an input shaft speed of the transmission reaches the target speed, wherein the step of performing torque intervention control comprises: detecting a motor speed, obtaining an operating point of the motor that maximizes charging power of the motor based on a charging power of the motor according to the motor speed, and controlling the motor torque based on the operating point of the motor.

### CROSS-REFERENCE TO RELATED APPLICATION

This application claims the benefit of priority to Korean Patent Application No. 10-2015-0150347, filed with the Korean Intellectual Property Office on Oct. 28, 2015, the entire contents of which are incorporated herein by reference.

### TECHNICAL FIELD

The present disclosure relates to an apparatus and a method for shift control of a hybrid vehicle.

### BACKGROUND

In general, a hybrid electric vehicle is a vehicle that driven by combining two or more different types of power sources.

The hybrid electric vehicle generally uses an engine and a motor/generator, and uses a motor/generator having beneficial low-speed torque characteristics as the primary power source at a low speed and uses an engine having a beneficial high-speed torque characteristic as the primary power source at a high speed. As a result, the hybrid electric vehicle may achieve high fuel efficiency and a reduction of exhaust gasses produced because of the use of the motor/generator during low-speed driving.

A transmission for converting power from an engine to a required torque according to a vehicle speed is mounted in the vehicle. In order to improve fuel consumption and minimize power losses, a multi-stage transmission has been studied. The hybrid vehicle including the multi-stage transmission performs torque intervention control by reducing a rotation speed of an input shaft of the transmission for fast shifting.

The above information disclosed in this Background section is only for enhancement of understanding of the background of the disclosure and therefore it may contain information that does not form the prior art and that is already known to a person of ordinary skill in the art.

### SUMMARY

The present disclosure has been made in an effort to provide an apparatus and a method for shift control of a hybrid vehicle that maximizes energy recovery during torque intervention control for fast shifting.

A method for shift control of a hybrid vehicle according to an exemplary embodiment of the present disclosure may include: determining a target speed of a transmission resulting from a shifting operation; and performing a torque intervention control that controls a motor torque in a state where an engine torque is maintained as a current torque until an input shaft speed of the transmission reaches a target speed, wherein the step of performing the torque intervention control may include: detecting a motor speed; obtaining an operating point of the motor that maximizes a charging power of the motor based on a charging power of the motor according to the motor speed; and controlling the motor torque based on the operating point of the motor.

The step of performing the torque intervention control may repeat the step of detecting the motor speed, the step of obtaining the operating point, and the step of controlling the motor torque.

The charging power of the motor may be differently determined according to a charging efficiency of a battery.

The controlling the motor torque may generate electrical energy by operating the motor as a generator such that some of the engine torque is transformed to electrical energy.

The method may further include controlling the motor torque to be equal to a toque before the torque intervention control is performed when the input shaft speed of the transmission reaches the target speed.

An apparatus for shift control of a hybrid vehicle according to another exemplary embodiment of the present disclosure may include: a map data storage for storing charging power of a motor according to a motor speed as a map data format; and a controller for performing torque intervention control that matches an input shaft speed of the motor to a target speed through motor torque control in a state where an engine torque is maintained as a current torque, wherein the controller determines an operating point of the motor that maximizes the charging power of the motor from the charging power of the motor stored in the map data storage during the torque intervention control, and controls the motor torque based on the operating point.

When the charging power of the motor is changed by controlling the motor torque, the controller may update the operating point of the motor based on the changed charging power.

The charging power of the motor may be differently determined according to a charging efficiency of a battery.

The controller may operate the motor as a generator such that some of the engine torque is transformed into electrical energy.

The controller may control the motor torque to be equal to a torque before the torque intervention control is performed when the input shaft speed of the transmission reaches the target speed.

According to an exemplary embodiment of the present disclosure, energy recovery is maximized and fuel consumption of the vehicle is improved.

### BRIEF DESCRIPTION OF THE DRAWINGS

FIG. 1 is a block diagram illustrating a hybrid vehicle according to an exemplary embodiment of the present disclosure.

FIG. 2 is a block diagram illustrating an apparatus for shift control according to an exemplary embodiment of the present disclosure.

FIG. 3 is a flowchart illustrating a method for shift control according to an exemplary embodiment of the present disclosure.

FIG. 4 is a graph for explaining the method for shift control of FIG. 3.

FIG. 5 is a table illustrating charging power according to a motor speed and a motor torque.

FIG. 6 is a table illustrating motor efficiency according to a motor speed and a motor torque.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

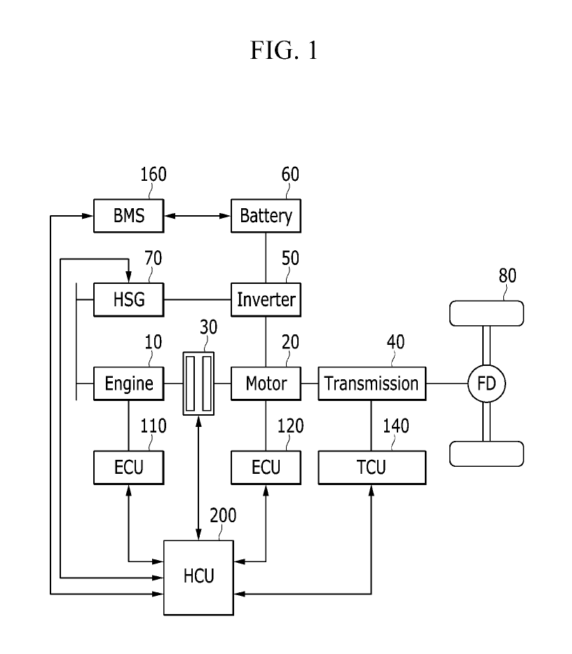

FIG. 1 is a block diagram illustrating a hybrid vehicle according to an exemplary embodiment of the present disclosure.

Referring to FIG. 1, a hybrid vehicle according to an exemplary embodiment of the present disclosure may include an engine 10, a motor 20, an engine clutch 30, a transmission 40, an inverter 50, a battery 60, an integrated starter-generator 70 and a wheel 80.

The engine 10 may generate power by burning a fuel.

The motor 20 may support the engine power, and selectively generate electrical energy by operating as a generator. The electrical energy generated by the motor 20 may be stored in the battery 60.

The engine clutch 30 may be disposed between the engine 10 and the motor 20, so as to connect or disconnect power between the engine 10 and the motor 20.

The transmission 40 may be directly connected with the motor 20, and transmit driving torque to the wheel 80 by converting the engine torque to a required torque.

The inverter 50 may convert a DC voltage outputted from the battery 60 to an AC voltage, and the AC voltage may be transmitted to the motor 20 or the integrated starter-generator 70.

The battery 60 may provide power to the motor 20 and the integrated starter-generator 70 through the inverter 50.

The integrated starter-generator 70 may start the engine 10 and selectively generate electrical power by being operated as a generator. The integrated starter-generator 70 may be called a hybrid starter & generator (HSG).

The hybrid vehicle according to an exemplary embodiment of the present disclosure may include at least one controller, such as a hybrid control unit (HCU) 200, an engine control unit (ECU) 110, a motor control unit (MCU) 120, a transmission control unit (TCU) 140 and a battery management system (BMS) 160.

The hybrid controller 200 may be an uppermost control unit and integrally control lower control units connected to the network to control an overall operation of the hybrid vehicle.

The engine control unit 110 may control overall operation of the engine in conjunction with the HCU 200. For example, the engine control unit 110 may control an intake air amount of the engine 10 by adjusting an opening of a throttle valve according to an acceleration intention, or command, of a driver and a driving condition.

The motor control unit 120 may control overall operation of the motor 20 in conjunction with the HCU 200. Further, the motor control unit 120 may control overall operation of the integrated starter-generator 70.

The transmission control unit 140 may control hydraulic pressure supplied to friction elements (e.g., clutch and/or brake) provided in the transmission 40 corresponding to an operation of a shift lever so as to control a shift-stage of the transmission 40.

The BMS 160 may detect information such as a voltage, a current, a temperature, etc., of the battery 60 to manage the charging state of the battery 60, and may control a charging current amount or a discharging current amount of the battery 60 so as to not be over-discharged to a lower limitation voltage or less or so as to not be over-charged to an upper limitation voltage or more.

The hybrid vehicle may be driven in a driving mode such as an electric vehicle (EV) mode, which may be a true electric vehicle mode, using only power of the motor 20. The hybrid vehicle may also operate in a hybrid vehicle (HEV) mode, which may use a rotational force of the engine 10 for main power and may use rotational force of the motor 20 as auxiliary power, and a regenerative braking (RB) mode for collecting braking and inertial energy during driving by braking or inertia of the vehicle through electrical generation of the motor 20 to charge the battery 60.

In the specification of the present disclosure, a controller may include the hybrid control unit 200, the engine control unit 110, the motor control unit 120, the transmission control unit 140 and the battery management system (BMS) 160.

The controller may be realized by one or more processors activated by a predetermined program, and the predetermined program may be programmed to perform each step of a shift control method of an automatic transmission according to embodiments of this disclosure.

The aforementioned various exemplary embodiments may be embodied in a recording medium which can be read by a computer or a similar device by using, for example, software, hardware, or a combination thereof.

According to a hardware embodiment, the aforementioned exemplary embodiments may be embodied by using at least one of ASICs (application specific integrated circuits), DSPs (digital signal processors), DSPDs (digital signal processing devices), PLDs (programmable logic devices), FPGAs (field programmable gate arrays), processors, controllers, microcontrollers, microprocessors and electrical units performing other functions.

According to a software embodiment, exemplary embodiments such as procedures and functions described in the present specification may be embodied by separate software modules. The software modules may each perform one or more functions and operations described in the present specification. A software code may be embodied by a software application written in an appropriate program language.

The controller may perform torque intervention control and motor torque control such that energy recovery is maximized in, or resulting from, a shifting operation.

Hereinafter, an apparatus for shift control according to an exemplary embodiment of the present disclosure will be described with reference to accompanying drawings.

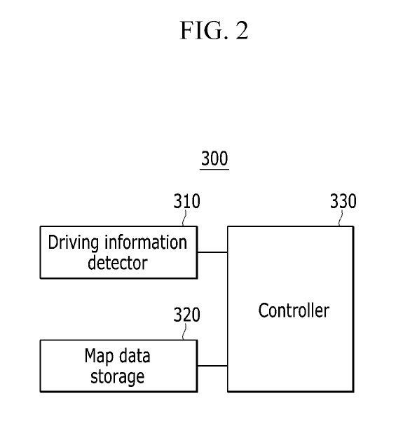

FIG. 2 is a block diagram illustrating an apparatus for shift control according to an exemplary embodiment of the present disclosure.

Referring to FIG. 2, the apparatus for shift control 300 according to an exemplary embodiment of the present disclosure may include a driving information detector 310, a map data storage 320 and a controller 330.

The driving information detector 310 may detect driving information of the vehicle. The driving information detected by the driving information detector 310 may be transmitted to the controller 330.

The driving information of the vehicle may include a vehicle speed, a motor speed, an engine speed, an operation amount of an acceleration pedal, an operation amount of a brake pedal, and an SOC (state of charge) of the battery. The vehicle speed, the motor speed and the engine speed may be detected by a vehicle speed sensor, a motor speed sensor and an engine speed sensor, respectively. The operation amount of the acceleration pedal may be detected by an APS (acceleration position sensor), and the operation amount of the brake pedal may be detected by a BPS (brake pedal position sensor). The SOC may be detected by the BMS 160.

The map data storage 320 may store charging power of the motor 20 according to the motor speed, the motor torque, and the SOC of the battery 60 as map data. The charging power of the motor 20 may be differently determined according to a charging efficiency of the battery 60.

The controller 330 may determine whether to perform shifting based on the driving information detected by the driving information detector 310. The controller 330 may perform shifting by controlling the transmission 40 when a required torque is changed or a vehicle speed is changed, thus accommodating, or satisfying, a shift condition. The controller 330 may control the transmission 40 so that a current shift stage is shifted to a target shift stage. That is, hydraulic pressure supplied to friction elements provided in the transmission 40 may be adjusted by a control signal outputted from the controller 330, and shifting from the current shift stage to the target shift stage may thus be realized.

A gear ratio may denote a ratio between an input shaft speed and an output shaft speed of the transmission 40, and may be set to be different according to shift stages. The gear ratio may be set to be high at a low speed region when a driving torque is high, but may be set to be low at a high speed region when the driving torque is low. That is, the gear ratio may be set to be low as the shift stage is upshifted.

The controller 330 may perform torque intervention control that matches an input shaft speed of the motor 20 to a target speed through motor torque control in a state where an engine torque is maintained as a current torque. For example, when the shift stage is upshifted (first shift stage to second shift state), the controller 330 may control the engine torque to be maintained as the current torque, and generate electrical energy by operating the motor 20 as a generator such that some of the engine torque is transformed to electrical energy and the electrical energy is stored in the battery.

As such, the input shaft speed of the transmission 40 may be decreased as some of the engine torque is transformed to electrical energy by the motor 20.

When the torque intervention control for up-shift is performed, the controller 330 may determine an operating point that maximizes instantaneous charging power of the motor 20 considering charging power of the motor 20 at a current speed of the motor 20, and may perform torque control of the motor 20.

When the torque intervention control for up-shift is performed, the rotation speed of the motor 20 may be changed by variation of the motor torque. The charging power of the motor 20 changed as the rotation speed of the motor 20 may be changed, and thus the operating point of the motor 20 that maximizes the charging power may be changed. Therefore, the controller 330 continuously may obtain the rotation speed of the motor 20 during the torque intervention control, update the operating point of the motor 20 corresponding to the variation of the rotation speed of the motor 20, and perform torque control of the motor 20 such that the instantaneous charging power of the motor 20 is maximized.

When the input shaft speed of the transmission 40 reaches the target speed through the torque intervention control, the controller 330 may stop the torque intervention control, and control the motor torque to be equal to a torque before the torque intervention control was performed. The shifting may be completed by controlling the transmission such that the gear of the target shift stage is engaged.

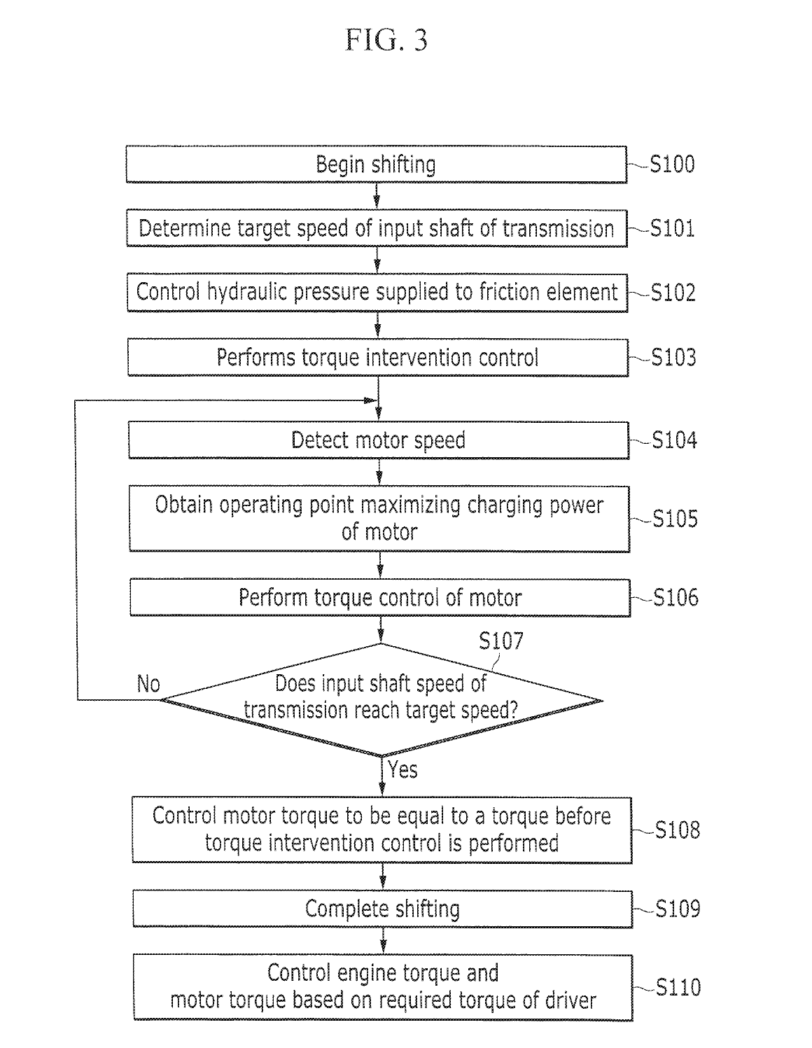

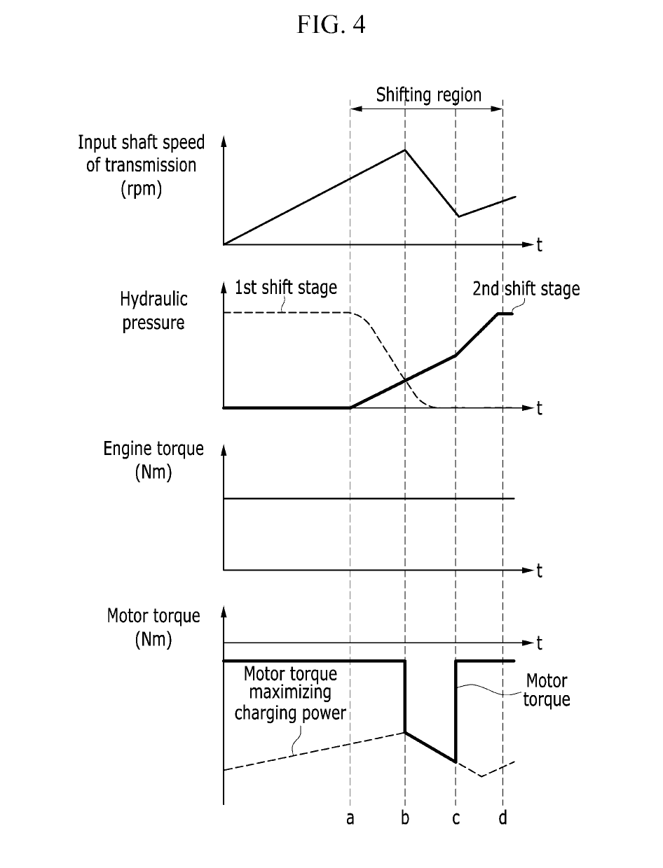

FIG. 3 is a flowchart illustrating a method for shift control according to an exemplary embodiment of the present disclosure. The method for shift control during up-shift is shown in FIG. 3. FIG. 4 is a graph for explaining the method for shift control of FIG. 3.

Referring to FIG. 3 and FIG. 4, the controller 330 may determine a target shift stage according to the driving information (for example, a required torque of a driver and a vehicle speed) detected by the driving information detector 310, and begin shifting to the target shift stage at step S100 (refer to ‘a’ of FIG. 4).

The controller 330 may determine a target speed of the input shaft of the transmission 40 based on the required torque, the vehicle speed, and the target shift stage at step S101.

The controller 330 may control hydraulic pressure supplied to a friction element corresponding to the target shift stage and a friction element corresponding to the current shift stage at step S102 (refer to ‘a-b’ region of FIG. 4). For example, a gear corresponding to the target shift stage (e.g., 2nd shift stage) may be engaged by increasing a hydraulic pressure supplied to an on-going friction element of the target shift stage by a control signal of the controller 330. A gear corresponding to a current shift stage (e.g., 1st shift stage) may be disengaged by decreasing a hydraulic pressure supplied to an off-going friction element of the current shift stage by the control signal of the controller 330.

The controller 330 may perform torque intervention control such that the input shaft speed of the transmission 40 quickly reaches the target speed at step S103 (refer to ‘b’ of FIG. 4).

The driving information detector 310 may detect a motor speed at step S104. The motor speed may be transmitted to the controller 330.

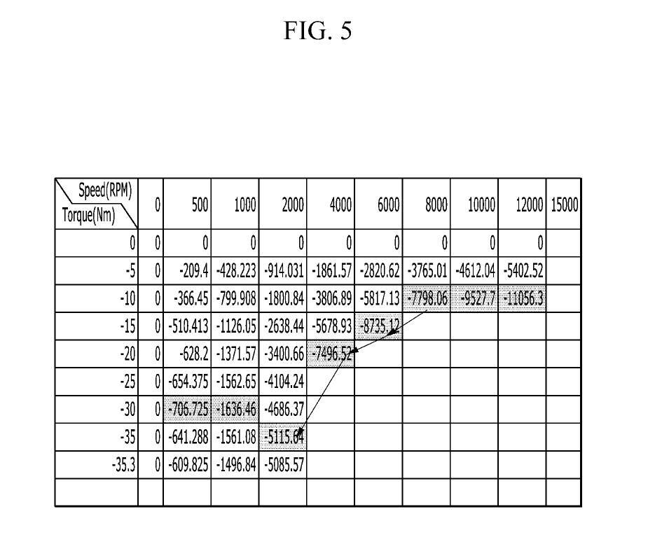

The controller 330 may obtain the operating point that maximizes the charging power of the motor 20 from the charging power according to the motor speed stored in the map data storage 320 at step S105. The charging power of the motor according to the motor speed may be stored in the map data storage 320 as a map table form (refer to FIG. 5).

The controller 330 may perform torque control of the motor 20 based on the operating point of the motor 20 at step S106.

The controller 330 may repeatedly perform steps S104 to S106 until the input shaft speed of the transmission 40 reaches the target speed through the torque control of the motor 20 at step S107 (refer to ‘b-c’ region of FIG. 4).

That is, when the motor speed and the motor torque are changed by the torque control of the motor 20, the controller 330 may re-obtain the operating point of the motor 20 corresponding to the changed motor power according to the changed motor speed and control motor torque based on the changed operating point. Even though the motor power is changed during the torque intervention control, it may be possible to perform the torque control of the motor 20 such that the instantaneous charging power according to the changed motor speed and torque is maximized, and thus energy recovery can be maximized during the torque intervention control.

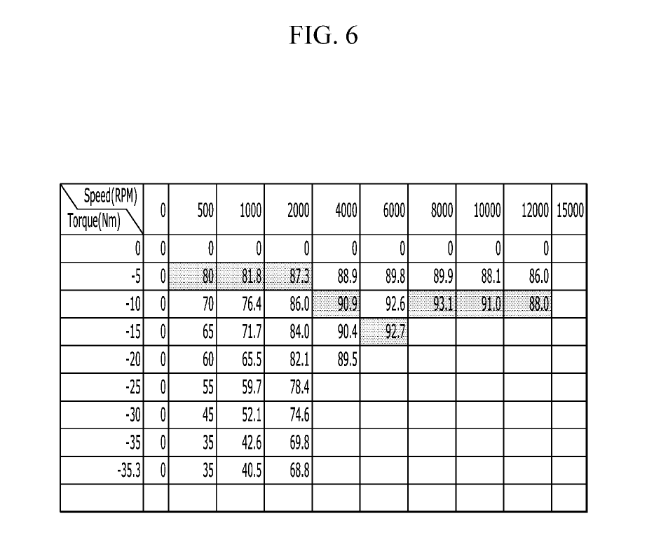

FIG. 5 is a table illustrating charging power according to a motor speed and a motor torque. In FIG. 5, hatched cells denote an operating point of the motor maximizing the charging power of the motor. FIG. 6 is a table illustrating motor efficiency according to a motor speed and a motor torque. In FIG. 6, hatched cells denote and operating point of the motor maximizing the motor efficiency. In FIG. 5 and FIG. 6, a negative torque means that the motor 20 is operated as a generator such that some of the engine torque is transformed to electrical energy by the motor 20. FIG. 5 and FIG. 6 show the charging power of the motor and the motor efficiency illustrating when the charging efficiency of the battery is constant, but when the charging efficiency of the battery is changed, the charging power of the motor and the motor efficiency may be changed.

Referring to FIG. 5, when the motor speed is changed from 8000 RPM to 2000 RPM during, or resulting from, a shifting operation, the controller 330 may perform the toque control of the motor 20 such that the charging power of the motor 20 is maximized (refer to hatched cells in FIG. 5).

Referring to FIG. 5, when the motor speed is 8000 RPM, the motor torque maximizing the charging power of the motor 20 may be minus 10 Nm.

Therefore, the controller 330 may control the motor 20 such that power generation torque of the motor 20 should be, or is, minus 10 Nm.

When the motor speed is decreased to 2000 RPM, the motor torque maximizing the charging power of the motor 20 may be minus 35 Nm. Therefore, the controller 330 may control the motor 20 such that the power generation torque of the motor 20 should be, or is, minus 35 Nm.

As shown FIG. 5 and FIG. 6, maximum efficiency of the motor 20 according to the motor speed and the motor torque (refer to hatched cells of FIG. 6) and maximum charging power according to the motor speed and the motor torque (refer to hatched cells of FIG. 5) may be different.

The controller 330 may control the motor 20 such that the efficiency of the motor 20 should be, or is, maximized. However, if the controller 330 controls the motor 20 such that the charging power of the motor is maximized, energy recovery may be maximized and fuel consumption of the vehicle may be improved.

In step S107, when the input shaft speed of the transmission 40 reaches the target speed, the controller 330 may control the motor torque to be equal to a torque before the torque intervention control is performed at step S108 (refer to ‘c’ of FIG. 4). The controller 330 may complete shifting to the target shift stage by increasing a hydraulic pressure supplied to the on-coming friction element of the target shift stage at step S109 (refer to ‘c-d’ region of FIG. 4).

When the shifting is completed, the controller 330 may determine an input torque of the transmission 40 according to the required torque of the driver, and control the engine torque and the motor torque based on the determined input torque of the transmission 40 at step S110.

According to an exemplary embodiment of the present disclosure, since the motor torque may be controlled such that the instantaneous charging power of the motor is maximized during, or resulting from, a shifting operation, energy recovery is maximized and fuel consumption of the vehicle can be improved.

A method according to an exemplary embodiment of the present disclosure may be executed through software. When being executed with software, constituent elements of the present disclosure may be code segments that execute necessary work. A program, or code segment, may be stored at a processor readable medium, or may be transmitted by a computer data signal that is coupled to a carrier in a communication network or a transmitting medium.

A computer readable recording medium includes all kinds of recording devices that store data that may be read by a computer system. A computer readable recording device may include, for example, a read-only memory (ROM), a random-access memory (RAM), a compact disc read-only memory (CD-ROM), a digital versatile disk-ROM (DVD_ROM), a digital versatile disk-RAM (DVD_RAM), a magnetic tape, a floppy disk, a hard disk, and optical data storage. Further, in the computer readable recording medium, codes that are distributed in a computer system that is connected to a network and that a computer may read with a distributed method may be stored and executed.

The foregoing drawings and a detailed description of the disclosure are illustrative of the present disclosure and are used for describing the present disclosure, but are not used for limitation of meaning or for limiting the scope of the present disclosure described in the claims. Therefore, a person of ordinary skill in the art can easily select and replace from the foregoing drawings and the detailed description. Further, a person of ordinary skill in the art may omit some of constituent elements described in this specification without degradation of performance or may add constituent elements in order to enhance performance. In addition, a person of ordinary skill in the art may change an order of method steps described in this specification according to a process environment or equipment. Therefore, the scope of the present disclosure should be determined by the appended claims and their equivalents instead of a described implementation.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A method for shift control of a hybrid vehicle, comprising:
determining a target speed of a transmission resulting from a shifting operation; and
performing torque intervention control that controls a motor torque in a state where an engine torque is maintained as a current torque until an input shaft speed of the transmission reaches a target speed,
wherein the step of performing torque intervention control comprises:
detecting a motor speed;
obtaining an operating point of the motor that maximizes charging power of the motor based on a charging power of the motor according to the motor speed; and
controlling the motor torque based on the operating point of the motor.

2. The method of claim 1, wherein the step of performing the torque intervention control repeats the step of detecting the motor speed, the step of obtaining the operating point, and the step of controlling the motor torque.

3. The method of claim 1, wherein the charging power of the motor is differently determined according to a charging efficiency of a battery.

4. The method of claim 1, wherein the step of the controlling the motor torque generates electrical energy by operating the motor as a generator such that some of the engine torque is transformed to electrical energy.

5. The method of claim 1, further comprising controlling the motor torque to be equal to a torque before the torque intervention control is performed when the input shaft speed of the transmission reaches the target speed.

6. An apparatus for shift control of a hybrid vehicle, comprising:
a map data storage for storing a charging power of a motor according to a motor speed as a map data format; and
a controller for performing a torque intervention control that matches an input shaft speed of the motor to a target speed through motor torque control in a state where an engine torque is maintained as a current torque,
wherein the controller determines an operating point of the motor that maximizes the charging power of the motor from the charging power of the motor stored in the map data storage during the torque intervention control, and controls the motor torque based on the operating point.

7. The apparatus of claim 6, wherein when the charging power of the motor is changed by controlling the motor torque, the controller updates the operating point of the motor based on the changed charging power.

8. The apparatus of claim 6, wherein the charging power of the motor is differently determined according to a charging efficiency of a battery.

9. The apparatus of claim 6, wherein the controller operates the motor as a generator such that some of the engine torque is transformed to electrical energy.

10. The apparatus of claim 6, wherein the controller controls the motor torque to be equal to a torque before the torque intervention control is performed when the input shaft speed of the transmission reaches the target speed.
